(19) United States
(12) Patent Application Publication
(10) Pub. No.: US 2021/0343454 A1
(43) Pub. Date: Nov. 4, 2021

(54) FEEDTHROUGH ASSEMBLIES, INDUCTION FURNACES INCLUDING SUCH FEEDTHROUGH ASSEMBLIES, AND RELATED METHODS

(71) Applicant: Battelle Energy Alliance, LLC, Idaho Falls, ID (US)

(72) Inventor: Blair K. Grover, Idaho Falls, ID (US)

(21) Appl. No.: 17/302,168

(22) Filed: Apr. 26, 2021

Related U.S. Application Data
(60) Provisional application No. 63/019,671, filed on May 4, 2020.

(51) Int. Cl. H01B 17/30; F27B 5/06; H05B 6/26

(52) U.S. Cl. CPC H01B 17/308; H05B 6/26; F27B 5/06

(57) ABSTRACT

A feedthrough assembly may include a feedthrough conductor, a first insulator, and a first metal gasket forming a seal between the feedthrough conductor and the first insulator. The feedthrough assembly may additionally include a body, and a second metal gasket forming a seal between the body and the first insulator. Methods of manufacturing such feedthrough assemblies may include compressing the first metal gasket between the feedthrough conductor and the first metal gasket to form a seal therebetween. The methods may further include compressing the second metal gasket between the body and the first insulator to form a seal therebetween. Induction furnace systems may include one or more such feed assemblies.

### CROSS-REFERENCE TO RELATED APPLICATION

This application claims the benefit under 35 U.S.C. § 119(e) of U.S. Provisional Patent Application Ser. No. 63/019,671, filed May 4, 2020, the disclosure of which is hereby incorporated herein in its entirety by this reference.

### GOVERNMENT RIGHTS

This invention was made with government support under Contract No DE-AC07-05-1D14517 awarded by the United States Department of Energy. The government has certain rights in the invention.

### TECHNICAL FIELD

The disclosure, in various embodiments, relates generally to feedthrough assemblies and related methods and systems. More particularly, the disclosure relates to feedthrough assemblies capable of use at high temperatures under vacuum and related methods and systems.

### BACKGROUND

Sealed chambers are useful for various purposes, such as for industrial processes, and research purposes. Sealed chambers may be utilized to maintain a controlled environment therein, contain hazardous materials, or other purposes. For example, a sealed chamber may be utilized to maintain a pressurized environment therein, to maintain a vacuum environment therein, to maintain a specific temperature therein, and/or to facilitate a chemical reaction therein.

It is often desirable or necessary to pass wires, devices, or other things through a wall of a sealed chamber, such as for monitoring the environment within the sealed chamber, and/or operating devices within the sealed chamber. To facilitate this, sealed fittings may be utilized to allow passage through the wall and prevent leaks between the sealed chamber and the outside environment. Certain factors, however, may present challenges in providing and maintaining a seal without leaks utilizing conventional sealed fittings. For example, factors such as large pressure differences between the sealed chamber and the outside environment, high temperatures, and limited space may present challenges in providing and maintaining a sealed chamber without leaks utilizing conventional seal fittings. Accordingly, new and improved devices to provide and maintain a sealed environment without leaks are highly sought after.

### BRIEF SUMMARY

In some embodiments of the present disclosure, a feedthrough assembly may include a feedthrough conductor, a first insulator, and a first metal gasket forming a seal between the feedthrough conductor and the first insulator. The feedthrough assembly may additionally include a body, and a second metal gasket forming a seal between the body and the first insulator.

In further embodiments of the present disclosure, methods of manufacturing feedthrough assemblies may include providing a feedthrough conductor, a first insulator, and a first metal gasket, and compressing the first metal gasket between the feedthrough conductor and the first metal gasket to form a seal therebetween. The methods may further include providing a body, and a second metal gasket, and compressing the second metal gasket between the body and the first insulator to form a seal therebetween.

In yet further embodiments of the present disclosure, Induction furnace systems may include one or more feed assemblies. The one or more feed systems may include a feedthrough conductor, a first insulator, and a first metal gasket forming a seal between the feedthrough conductor and the first insulator. The feedthrough assembly may additionally include a body, and a second metal gasket forming a seal between the body and the first insulator.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a simplified schematic view of an induction furnace system according to an embodiment of the present disclosure;

FIG. 2 is a cross-sectional view of a prior art feedthrough assembly;

FIG. 3 is a cross-sectional view of a feedthrough assembly according to an embodiment of the present disclosure;

FIG. 4 is a cross-sectional view of a feedthrough conductor of the feedthrough assembly of FIG. 3;

FIG. 5 is an isometric view of a first metal gasket of the feedthrough assembly of FIG. 3;

FIG. 6 is an isometric view of a second metal gasket of the feedthrough assembly of FIG. 3;

FIG. 7 is an isometric view of an insulator of the feedthrough assembly of FIG. 3;

FIG. 8 is an isometric view of another insulator of the feedthrough assembly of FIG. 3;

FIG. 9 is an isometric view of yet another insulator of the feedthrough assembly of FIG. 3;

FIG. 10 is a cross-sectional view of a body of the feedthrough assembly of FIG. 3; and

FIG. 11 is a cross-sectional view of a nut of the feedthrough assembly of FIG. 3.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not necessarily meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. For the most part, details concerning timing considerations and the like have been omitted where such details are not necessary to obtain a complete understanding of the present disclosure and are within the abilities of persons of ordinary skill in the relevant art.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

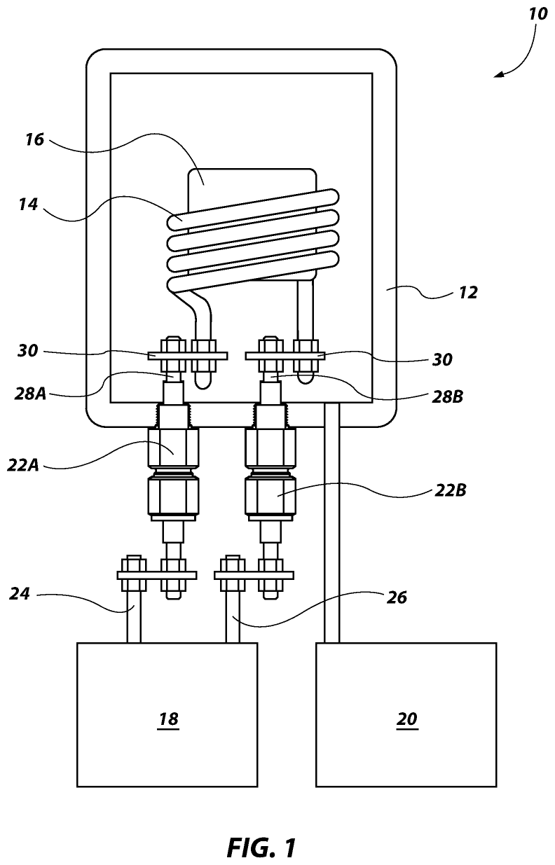

FIG. 1 shows a simplified schematic view of an induction furnace system 10 according to an embodiment of the present disclosure. The induction furnace system 10 may include a vacuum chamber 12 having induction coils 14 located therein. A crucible 16 may be located within the induction coils 14, and a power source 18 may be located outside of the vacuum chamber 12. The induction furnace system 10 may also include a vacuum system 20, which may include a vacuum pump, coupled to the vacuum chamber 12.

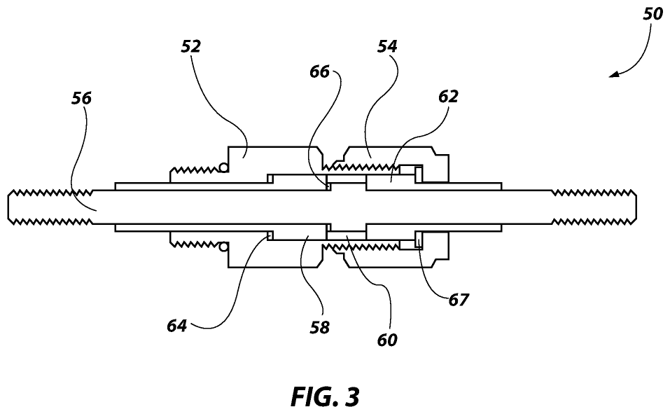

The induction furnace system 10 may include at least one feedthrough assembly 22A, 22B, as will be described in further detail below with regard to FIG. 3. Each feedthrough assembly 22A, 22B may be coupled to a wall of the vacuum chamber 12. In some embodiments, the induction furnace system 10 may include at least two feedthrough assemblies 22A, 22B coupled to and extending through a base plate of the vacuum chamber 12. A first electrical line 24 of the power source 18 located outside of the vacuum chamber may be electrically connected to a first end of the induction coils 14 located inside the vacuum chamber 12 via a first feedthrough assembly 22A. Likewise, a second electrical line 26 of the power source 18 located outside of the vacuum chamber 12 may be electrically connected to a second end of the induction coils 14 located inside the vacuum chamber 12 via the second feedthrough assembly 22B.

The induction furnace system 10 may be relatively small and, in some embodiments, may be used to produce alloy buttons or castings of metal fuel (e.g., uranium, or a uranium alloy), such as for research purposes. For example, the induction furnace system 10 may be used on a bench top, in fume hoods and/or in gloveboxes.

Connecting electrical power from the power source 18 to the induction coils 14 is often challenging due to space limits of the induction furnace system 10. The vacuum chamber 12 is required when operated in air to melt metal fuel, so as to prevent reactions between the molten metal fuel and the air. Additionally, several other undesirable reactions may occur with other materials used in the induction furnace system 10 if exposed to air. For example, graphite may be utilized in the induction furnace system 10, which will react with air at temperatures above 450° C. Typical temperatures of the induction furnace system 10 may be between about 1250° C. and 1550° C. Limited space is available through the base plate of the vacuum chamber 12 and a relatively small feedthrough is needed. Most vacuum-sealed power feedthrough assemblies are a flanged type connection. A threaded connection is preferred due to space and makes replacement, if needed, simpler to replace.

Induction coils are typically made from copper tubing, which is cooled by circulating a coolant therethrough. However, when heating and alloying nuclear materials, such as metal fuel, it is not desirable to have coolant, such as water, inside of the vacuum chamber 12. Accordingly, the induction coils 14 of the induction furnace system 10 may be solid copper, without any internal coolant channels therein. Heat may be generated in the induction coils 14 by electric current flowing through the induction coils 14 when in operation. Heat may also be transmitted to the induction coils 14 by the crucible 16, and the heated materials within the crucible 16, due to the crucible 16 being located within the inductions coils 14. The induction coils 14, lacking any active cooling such as coolant channels, can reach temperatures up to 700° C. when in operation.

Heat from the induction coils 14 may be transmitted to feedthrough conductors 28A, 28B, as they are coupled to the induction coils 14, such as by bus bars 30, to provide electric current. Due to the temperature of the induction coils 14, which are not actively cooled, the temperature of the feedthrough conductors 28A, 28B may be quite high. For example, the feedthrough conductors 28A, 28 B may reach temperatures of 250° C., or even higher. Because of the elevated temperature, a typical polymer seal will fail in vacuum. Other higher temperature materials are available, but do not provide the vacuum-tight seal required.

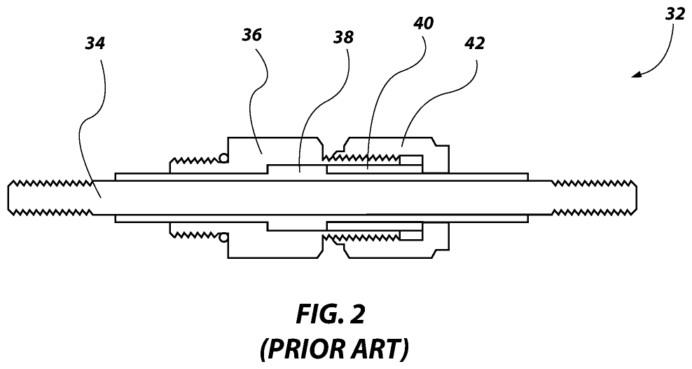

A feedthrough assembly 32, as shown in a cross-sectional view in FIG. 2, is available that uses a Straight Thread O-ring (STOR) sealing system. Feedthrough assemblies like feedthrough assembly 32 are sold under the tradename “EGT Series” available from Conax Technologies of Buffalo, N.Y. This STOR type of connection is relatively small and requires little space to configure. The feedthrough assembly 32 includes a feedthrough conductor 34 and a body 36 with a solid sealant 38 located therebetween. A follower 40 is positioned against a shoulder formed in the solid sealant 38. When a nut 42 is tightened on the body 36, the nut 42 applies a force on the follower 40, which causes the follower 40 to compress the solid sealant 38 between the body 36 and the follower 40. The solid sealant 38 of the feedthrough assembly 32 is available in various sealing materials suitable for relatively high temperatures, but does not provide the seal required. Accordingly, a feedthrough assembly that can withstand relatively high temperatures with improved sealing is needed.

A cross-sectional view of a feedthrough assembly 50 according to an embodiment of the present disclosure is shown in FIG. 3. The feedthrough assembly 50 may be utilized as the feedthrough assemblies 22A, 22B in the induction furnace system 10 described with regard to FIG. 1. The feedthrough assembly 50 may include a body 52, and a nut 54, much like the feedthrough assembly 32 of FIG. 2. The other components of the feedthrough assembly 50 are unique to feedthrough assemblies according to embodiments of the present disclosure.

Referring again to FIG. 3, the feedthrough assembly 50 may include a feedthrough conductor 56 extending through the body 52 and the nut 54. A first insulator 58, a second insulator 60, and a third insulator 62 may electrically isolate the feedthrough conductor 56 from the body 52 and the nut 54. A first metal gasket 64 may be located between the first insulator 58 and the body 52 and a second metal gasket 66 may be locate between a shoulder of the feedthrough conductor 56 and the first insulator 58. A flat washer 67 may be located between a shoulder of the third insulator 62 and the nut 54.

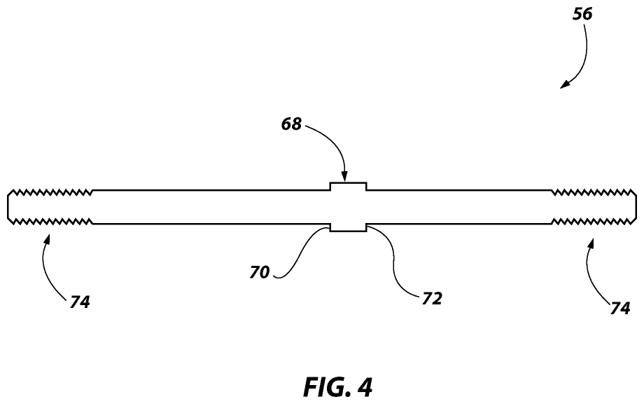

The feedthrough conductor 56, as shown in a cross-sectional view in FIG. 4, may be solid copper, such as alloy 101 temper H04 copper, without any cooling channels therein. The feedthrough conductor 56 may be generally cylindrical and have a length sufficient for a first end of the feedthrough conductor 56 to extend out of an opening of the nut 54 and a second end of the feedthrough conductor 56 to extend out of an opening of the body 52. The feedthrough conductor 56 may include a radially extending portion 68 having a first shoulder 70 at one end and a second shoulder 72 at the other end. Each of the first end and the second end of the feedthrough conductor 56 may include a threaded portion 74 to facilitate the threading of fasteners thereto.

The first metal gasket 64, as shown in an isometric view in FIG. 5, may be fabricated from a copper sheet or bar, such as alloy 101 copper. Optionally, the first metal gasket 64 may be annealed to soft temper. The first metal gasket 64 may have an inner diameter that is just larger than an outer diameter of a portion of the first insulator 58, and may have an outer diameter that is smaller than a diameter of a portion of the body 52, to facilitate the positioning of the first metal gasket 64 therebetween. In some embodiments, the first metal gasket 64 may have a thickness of about 0.050 inches (about 1.27 mm).

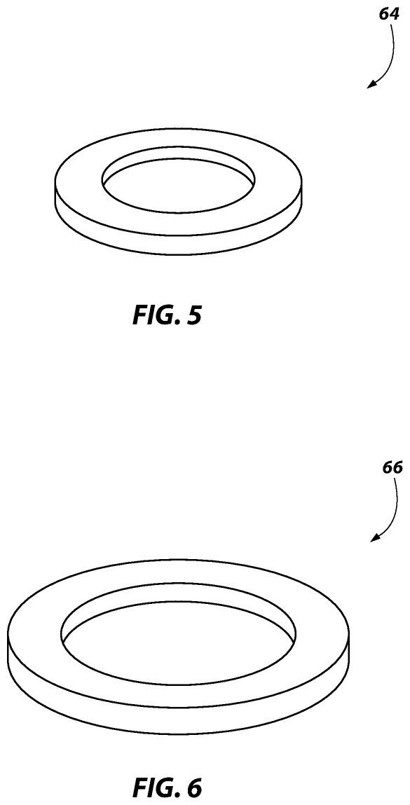

The second metal gasket 66, as shown in an isometric view in FIG. 6, may be fabricated from a copper sheet or bar, such as alloy 101 copper. Optionally, the second metal gasket 66 may be annealed to soft temper. The second metal gasket 66 may have an inner diameter that is just larger than an outer diameter of a portion of the feedthrough conductor 56, and may have an outer diameter that is smaller than a diameter of a portion of the second insulator 60, to facilitate the positioning of the second metal gasket 66 therebetween. In some embodiments, the second metal gasket 66 may have a thickness of about 0.050 inches (about 1.27 mm).

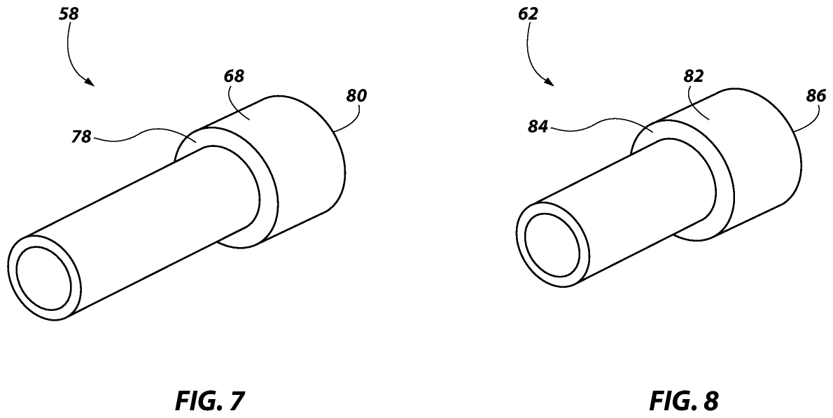

The first insulator 58, as shown in an isometric view in FIG. 7, may have a generally tubular shape with a radially extending portion 76 at a first end having a larger outer diameter than the portion at the second end. The radially extending portion 76 may include a shoulder 78 and an end surface 80. The first insulator 58 may be comprised of a dielectric material, such as a ceramic material. In some embodiments, the first insulator 58 may be comprised of alumina.

The third insulator 62, as shown in an isometric view in FIG. 8, may be shaped substantially the same as the first insulator 58, but may have a shorter length. Accordingly, the third insulator 62 may have a generally tubular shape with a radially extending portion 82 at a first end having a larger outer diameter than the portion at the second end. The radially extending portion 82 may include a shoulder 84 and an end surface 86. The third insulator 62 may be comprised of a dielectric material, such as a ceramic material. In some embodiments, the third insulator 62 may be comprised of alumina. For example, the first insulator 58 and the third insulator 62 may be manufactured from alumina insulator material available from Conax Technologies of Buffalo, N.Y.

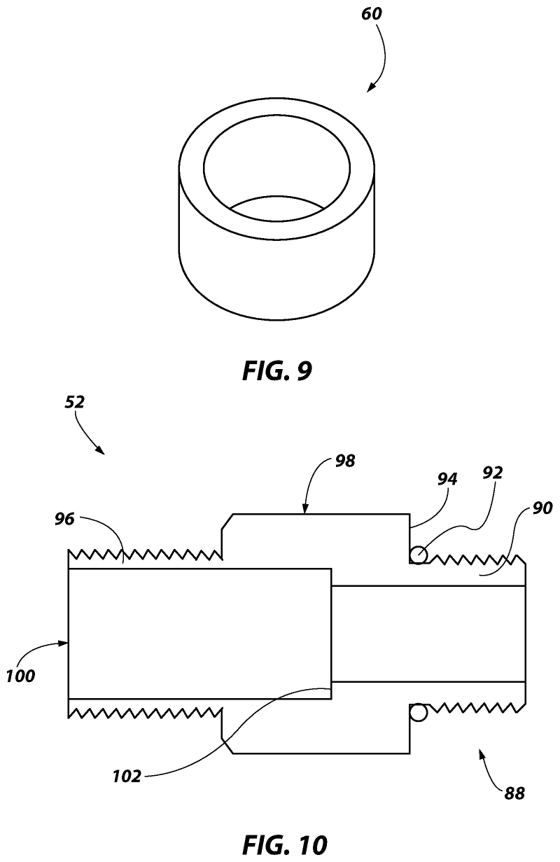

The second insulator 60, as shown in an isometric view in FIG. 9, may have a generally tubular shape. The second insulator 60 may be sized to substantially fill the space between the radially extending member 68 of the feedthrough conductor 34 and the body 52. The second insulator 60 may be comprised of a dielectric material, such as a ceramic material. In some embodiments, the second insulator 60 may be formed from a material comprising magnesium oxide, aluminum oxide, and silica. For example, the second insulator 60 may be manufactured from a material sold under the tradename “LAVA” available from Conax Technologies of Buffalo, N.Y.

It is important that the material selected for each of the first insulator 58, the second insulator 60, and the third insulator 62 be dielectric to electrically isolate the feedthrough conductor 56 from the body 52 and the nut 54. It is also important that the material selected for each of the first insulator 58, the second insulator 60, and the third insulator 62 be resistant to heat.

The body 52, as shown in a cross-sectional view in FIG. 10, may be made of a metal, such as steel. The body 52 may include a male Straight Thread O-ring (STOR) sealing system 88 at one end. The STOR sealing system 88 may include a first nipple 90 with straight (i.e., non-tapered) threads and an O-ring 92 positioned between the first nipple and a shoulder 94. The body 52 may include a second nipple 96 with straight thread at the other end. An outer portion 98 of the body 52 between the first nipple 90 and the second nipple 96 may be shaped to receive a tool, such as a wrench, to facilitate the application of torque to the body 52. For example, the outer portion 98 of the body 52 may be shaped similarly to a hex nut (e.g., having the shape of an extruded hexagon). The body 52 may include a bore 100 therein having a first diameter at one end and a second diameter, larger than the first diameter, at the other end with a shoulder 102 located at the transition therebetween.

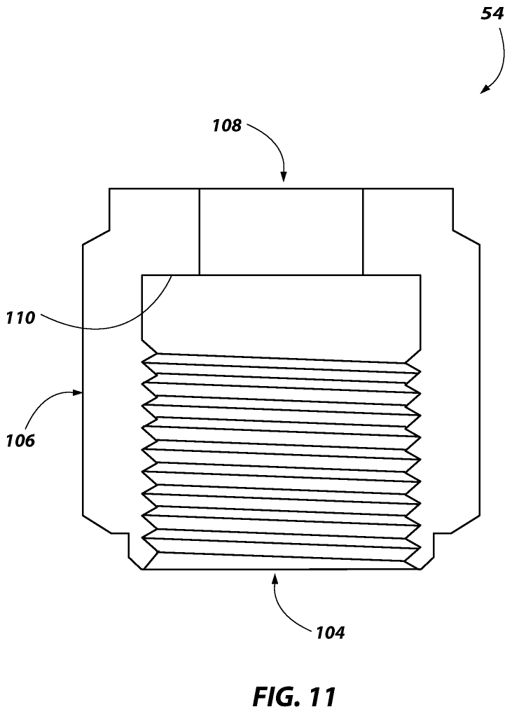

The nut 42, as shown in a cross-sectional view in FIG. 11, may be made of a metal, such as steel. The nut 42 may include a threaded bore 104 sized and configured to mate with the second nipple 96 of the body 52. An outer portion 106 of the nut 42 may be shaped to receive a tool, such as a wrench, to facilitate the application of torque to the nut 42. For example, the outer portion 106 of the nut 42 may be shaped similarly to a hex nut (e.g., having the shape of an extruded hexagon). The nut 42 may include an aperture 108 at one end extending to the threaded bore 104 and having a diameter that is smaller than a diameter of the threaded bore with a shoulder 110 located at the transition between the aperture 108 and the threaded bore 104.

Referring again to FIG. 3, to assemble the feedthrough assembly 50, the first metal gasket 64 may be inserted into the bore 100 of the body 52 and positioned on the shoulder 102. The first insulator 58 may then be inserted into the bore 100 with the shoulder 78 of the first insulator resting on the first metal gasket 64. The second metal gasket 66 and the second insulator 60 may then be inserted into the bore 100 both resting on the end surface 80 of the first insulator 58. The feedthrough conductor 56 may be inserted into the bore 100 with the first shoulder 70 of the radially extending member 68 resting on the second metal gasket 66. The third insulator 62 may then be inserted over the feedthrough conductor 56 with the end surface 86 of the third insulator 62 resting on the second shoulder 72 of the radially extending member 68 of the feedthrough conductor 56. The flat washer 67 may then be placed over the third insulator 62 and rest on the shoulder 84 of the third insulator 62. Finally, the nut 54 may be installed over the flat washer 67 and rotated to mate the threads within the threaded bore 104 of the nut 54 with the threads of the second nipple 96 of the body 52. Torque may then be applied with one or more tools, such as a wrench and/or a torque wrench, and a torque may be applied to compress the first metal gasket 64 between the shoulder 78 of the first insulator 58 and the shoulder 102 of the body 52 and compress the second metal gasket 66 between the end surface 80 of the first insulator 58 and the first shoulder 70 of the radially extending member 68 of the feedthrough conductor 56. The compressive forces may thus create metal-to-metal seals. Additionally, the feedthrough conductor 56 may be utilized as part of the seal and still be used for its primary function of electric current flow to the induction coil.

Referring to FIG. 1, the assembled feedthrough assembly 22A, 22B, 50 may then be installed onto the vacuum chamber 12 by mating the threads of the first nipple 90 with a threaded port of the vacuum chamber 12 and applying a torque to the body 52 to compress the O-ring 92 between the body 52 and a surface of the vacuum chamber 12 to form a seal therebetween. As the O-ring 92 may be spaced somewhat from the feedthrough conductor 28A, 28B, 56, the heat experienced by the O-ring 92 during operation may be within a suitable operating temperature of the O-ring 92 and a seal may be maintained.

Induction furnace systems according to embodiments of the present disclosure, such the induction furnace system 10 with feedthrough assemblies 22A, 22B, 50, may be very robust and may have a leak rate of helium at or less than 10⁻⁸ cubic centimeters per second at 1 Atm (101.3 kPa) of pressure and a temperature of 25° C. after over 200 heat cycles while other seals rated for temperatures up to 250° C. have failed.

Additionally, induction furnace systems according to embodiments of the present disclosure, such the induction furnace system 10 with feedthrough assemblies 22A, 22B, 50, may have reduced dross (e.g., contaminates) when utilized for melting metal.

While the disclosure is susceptible to various modifications and alternative forms, specific embodiments have been shown by way of example in the drawings and have been described in detail herein. However, the disclosure is not intended to be limited to the particular forms disclosed. Rather, the disclosure is to cover all modifications, equivalents, and alternatives falling within the scope of the disclosure as defined by the following appended claims and their legal equivalents.

What is claimed is:

1. A feedthrough assembly comprising:
a feedthrough conductor;
a first insulator; and
a first metal gasket forming a seal between the feedthrough conductor and the first insulator.

2. The feedthrough assembly of claim 1, further comprising:
a body; and
a second metal gasket forming a seal between the body and the first insulator.

3. The feedthrough assembly of claim 2, wherein each of the first metal gasket and the second metal gasket is comprised of copper.

4. The feedthrough assembly of claim 3, wherein the feedthrough conductor is comprised of copper.

5. The feedthrough assembly, of claim 4, wherein the feedthrough conductor is comprised of solid copper, with no cooling channels therein.

6. The feedthrough assembly of claim 1, wherein the feedthrough conductor includes a radially extending portion and wherein the first metal gasket is positioned against a shoulder of the radially extending portion.

7. The feedthrough assembly of claim 2, wherein the body includes a threaded nipple extending therefrom and configured to mate with a threaded opening of a vacuum chamber.

8. A method of manufacturing a feedthrough assembly, the method comprising:
providing a feedthrough conductor, a first insulator, and a first metal gasket; and
compressing the first metal gasket between the feedthrough conductor and the first metal gasket to form a seal therebetween.

9. The method of claim 8, further comprising:
providing a body, and a second metal gasket; and
compressing the second metal gasket between the body and the first insulator to form a seal therebetween.

10. The method of claim 9, wherein providing each of the first metal gasket and the second metal gasket comprises providing a first metal gasket of copper and a second metal gasket of copper.

11. The method of claim 10, wherein providing the feedthrough conductor comprises providing a feedthrough conductor of copper.

12. The method of claim 10, wherein providing the feedthrough conductor comprises providing a feedthrough conductor of solid copper, with no cooling channels therein.

13. The method of claim 8, wherein compressing the first metal gasket between the feedthrough conductor and the first insulator comprises compressing the first metal gasket between a shoulder of a radially extending portion of the feedthrough conductor and the first insulator.

14. The method of claim 9, wherein providing the body comprises providing a body that includes a threaded nipple extending therefrom configured to mate with a threaded opening of a vacuum chamber.

15. An induction furnace system comprising:
a vacuum chamber; and
at least one feedthrough assembly coupled to the vacuum chamber, the at least one feedthrough assembly comprising:
a feedthrough conductor;
a first insulator; and
a first metal gasket forming a seal between the feedthrough conductor and the first insulator.

16. The induction furnace system of claim 15, wherein the at least one feedthrough assembly further comprises:
a body; and
a second metal gasket forming a seal between the body and the first insulator.

17. The induction furnace system of claim 16, wherein each of the first metal gasket and the second metal gasket is comprised of copper.

18. The induction furnace system of claim 17, wherein the feedthrough conductor is comprised of copper.

19. The induction furnace system of claim 17, wherein the feedthrough conductor is comprised of solid copper, with no cooling channels therein.

20. The induction furnace system of claim 19, wherein the feedthrough conductor includes a radially extending portion and wherein the first metal gasket is positioned against a shoulder of the radially extending portion.
